(19) United States
(12) Patent Application Publication
(10) Pub. No.: US 2004/0131798 A1
(43) Pub. Date: Jul. 8, 2004

(54) Liquid crystal display device and method of producing the same

(75) Inventor: Shingo Kataoka, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORPORATION

(21) Appl. No.: 10/698,971

(22) Filed: Oct. 31, 2003

(30) Foreign Application Priority Data
Oct. 31, 2002 (JP) 2002-318794

(51) Int. Cl. C09K 19/00

(52) U.S. Cl. 428/1.1

(57) ABSTRACT

A liquid crystal display device provided with monostable ferroelectric liquid crystals suited for a field sequential drive for displaying dynamic images, or a liquid crystal display device featuring excellent contrast as a result of obtaining good alignment. An upper substrate on which is arranged an upper alignment control layer that is formed on an upper electrode and is performed an aligning treatment, is stuck together with a lower substrate on which is arranged a lower alignment control layer that is formed on a lower electrode and is performed an aligning treatment in the same direction as the upper alignment control layer. Monostable ferroelectric liquid crystals are sealed between the upper alignment control layer and the lower alignment control layer, the phase of the liquid crystals is transited from the isotropic phase or the nematic phase into the chiral smectic phase while applying a DC voltage across the upper electrode and the lower electrode to uniformalize the helical axes of the liquid crystal molecules and, at the same time, the direction in which the chevron-layer structure is bent is transited into a direction opposite to the direction in which the chevron-layer structure is bent when the DC voltage is not applied.

### BACKGROUND OF THE INVENTION

1. Field of the Invention

This invention relates to a ferroelectric liquid crystal display device and, particularly, to a liquid crystal display device provided with monostable ferroelectric liquid crystals suited for a field sequential drive for displaying dynamic images. Here, the field sequential drive stands for a drive method for displaying images (dynamic images) by, for example, sequentially emitting colors such as R, G and B in time series from a backlight unit without providing color filters such as of R (red), G (green) and B (blue) on the substrate of a liquid crystal display device. To utilize this method, it is necessary to use liquid crystals having a very short response time in the display of half tone.

2. Description of the Related Art

In recent years, a liquid crystal display device has been much used as an output device for portable electronic equipment such as portable personal computers and the like. The liquid crystal display device is small in size and is light in weight as compared to the CRTs (cathode-ray tubes) and is suited for use in the portable electronic equipment.

However, it has been pointed out that the liquid crystal display devices are inferior to the CRTs with respect to wide viewing angle characteristics and high response time. It has therefore been desired to provide a liquid crystal display device which features excellently wide viewing angle characteristics and high response time characteristics.

At present, a majority of liquid crystal display devices (liquid crystal panels) employing active elements are based on a TN (twisted nematic) mode in which nematic liquid crystals having a positive dielectric anisotropy are aligned nearly horizontally with respect to the substrate surface, and the direction of alignment of the liquid crystal molecules is twisted by 90° between the opposing substrates. However, the liquid crystal display device of the TN mode has a fatal defect in that it has a narrow viewing angle and a long response time.

In recent years, therefore, there has been announced and mass-produced a liquid crystal display device based on a VA (vertically aligned) mode in which nematic liquid crystals having a negative dielectric anisotropy are aligned nearly vertically to the substrate surface to realize a wide viewing angle and a short response time while improving defects inherent in the TN mode. To eliminate the dependence on the viewing angle and reversal of brightness, however, it becomes necessary to divide the alignment and to use an expensive optically compensated film, resulting in an increase in the cost. Even from the standpoint of response time, dynamic images cannot still be displayed to a sufficient degree comparable to that of CRTs. As far as nematic liquid crystals are used, it is considered that there is a limitation on improving the response time.

In such circumstances, attention has recently been given to a liquid crystal display device using ferroelectric liquid crystals or anti-ferroelectric liquid crystals featuring a wide viewing angle and a response time which is about 1000 times as fast as that of the TN system. Among them, the conventional bistable ferroelectric liquid crystals are accompanied by such problems that it is difficult to obtain a half tone display and that the practicable temperature range is narrow since the smectic A-phase is deviated toward the high temperature side. On the other hand, the anti-ferroelectric liquid crystals which have once drawn attention make it possible to easily obtain a half tone display, but involving such problems as limited range of anti-ferroelectric materials from which to choose, and difficult improvement of the specifications such as alignment, response time and temperature characteristics for realizing practicable liquid crystals.

JP-A-2001-81466

JP-A-2001-264822

Jpn. J. Appl. Phys. Vol. 38, 1999, pp. 5977-5983

In order to improve the above many defects, ferroelectric liquid crystals that exhibit monostability are now considered to be promising. This material features (1) an intermediate tone display based on the active matrix drive owing to its monostability and (2) a wide temperature range in the smectic C*-phase and a very small change in the tilted angle due to temperature, since there exists no smectic A-phase on the high temperature side (which may be, for example, about 70° C. to 90° C.). The response time is short and is in the order of microseconds, as a matter of course. However, a sole serious problem is that it is difficult to control the alignment of the monostable ferroelectric liquid crystals. At present, no concrete method has been established for obtaining a favorable alignment. Under the conditions that have heretofore been employed, it is difficult to obtain a state of alignment of a level which imposes no problem in practice.

### SUMMARY OF THE INVENTION

The present invention was accomplished in view of the above points, and its object is to provide a liquid crystal display device that features good alignment and excellent contrast while utilizing half tone display characteristics, high-speed response and wide temperature range characteristics of the monostable ferroelectric liquid crystals.

The above object is accomplished by a liquid crystal display device comprising:

an upper substrate on which are arranged an upper electrode for applying a voltage, and an upper alignment control layer formed on the upper electrode and performed an aligning treatment;

a lower substrate on which are arranged a lower electrode for applying a voltage in cooperation with the upper electrode, and a lower alignment control layer formed on the lower electrode and performed an aligning treatment in the same direction as the upper alignment control layer; and

monostable ferroelectric liquid crystals sealed between the upper alignment control layer and the lower alignment control layer, and forming a chevron-layer structure which is so bent that the inside from both sides of the upper and lower alignment control layers is protruded in the direction of the aligning treatment.

The above object is further accomplished by a method of producing a liquid crystal display device comprising:

sticking an upper substrate on which is arranged an upper alignment control layer that is formed on an upper electrode and is performed an aligning treatment, together with a lower substrate on which is arranged a lower alignment control layer that is formed on a lower electrode and is performed an aligning treatment in the same direction as the upper alignment control layer;

sealing monostable ferroelectric liquid crystals between the upper alignment control layer and the lower alignment control layer; and

transiting the phase of the monostable ferroelectric liquid crystals from the isotropic phase or the (chiral) nematic phase into the chiral smectic phase while applying a DC voltage across the upper electrode and the lower electrode to uniformalize the helical axes of the liquid crystal molecules and, at the same time, transiting the direction in which the chevron-layer structure is bent into a direction opposite to the direction in which the chevron-layer structure is bent when the DC voltage is not applied.

### BRIEF DESCRIPTION OF THE DRAWINGS

FIGS. 1A and 1B are diagrams illustrating a state of alignment in the SmC*-phase of when there is applied no aligning treatment voltage in a liquid crystal display device having monostable ferroelectric liquid crystals according to an embodiment of the invention;

FIGS. 2A and 2B are diagrams illustrating a state of alignment in the SmC*-phase of when there is applied an aligning treatment voltage in the liquid crystal display device having monostable ferroelectric liquid crystals according to the embodiment of the invention;

FIGS. 3A and 3B are diagrams illustrating a pre-tilt expression direction and two states of alignment in the SmC*-phase in the liquid crystal display device having monostable ferroelectric liquid crystals according to the embodiment of the invention, wherein FIG. 3A is a diagram schematically illustrating a state of observing the liquid crystal layer in a direction perpendicular to the substrate surface, and FIG. 3B is a sectional view cut along the line A-A in FIG. 3A;

FIG. 4 is a view illustrating a state of liquid crystal alignment in the liquid crystal display device having monostable ferroelectric liquid crystals according to the first example of the invention;

FIG. 5 is a diagram comparing the characteristics of the aligned film materials according to a second example in the liquid crystal display device having monostable ferroelectric liquid crystals according to the embodiment of the invention;

FIGS. 6A to 6E are views illustrating changes in the state of alignment depending upon the aligning treatment voltages according to a third example in the liquid crystal display device having monostable ferroelectric liquid crystals according to the embodiment of the invention, wherein FIGS. 6A to 6C illustrate the states on the surface of the liquid crystal layer obtained by applying aligning treatment voltages of DC 3.5 V, DC 4.5 V and DC 6.0 V, FIG. 6D is a diagram illustrating a relationship of arrangement between the direction of parallel rubbing of the upper and lower alignment control layers 18, 20 of liquid crystal cells shown in FIGS. 6A to 6C and the polarizing plates (not shown) stuck to both surfaces of the glass substrate of the liquid crystal cell and FIG. 6E is a diagram illustrating a curve of voltage vs. transmission factor characteristics of the liquid crystal cell; and

FIGS. 7A and 7B are views illustrating changes in the pre-tilt angle and in the alignment of when an alkyl side chains are imparted to the liquid crystalline material without having alkyl side chain according to a fourth example in the liquid crystal display device having monostable ferroelectric liquid crystals according to the embodiment of the invention, wherein FIG. 7A illustrates the state on the surface of the liquid crystal layer of when the amount of the alkyl side chains is relatively small (sample A) and FIG. 7B illustrates the state on the surface of the liquid crystal layer of when the amount of the alkyl side chains is relatively large (sample B).

### DESCRIPTION OF THE PREFERRED EMBODIMENTS

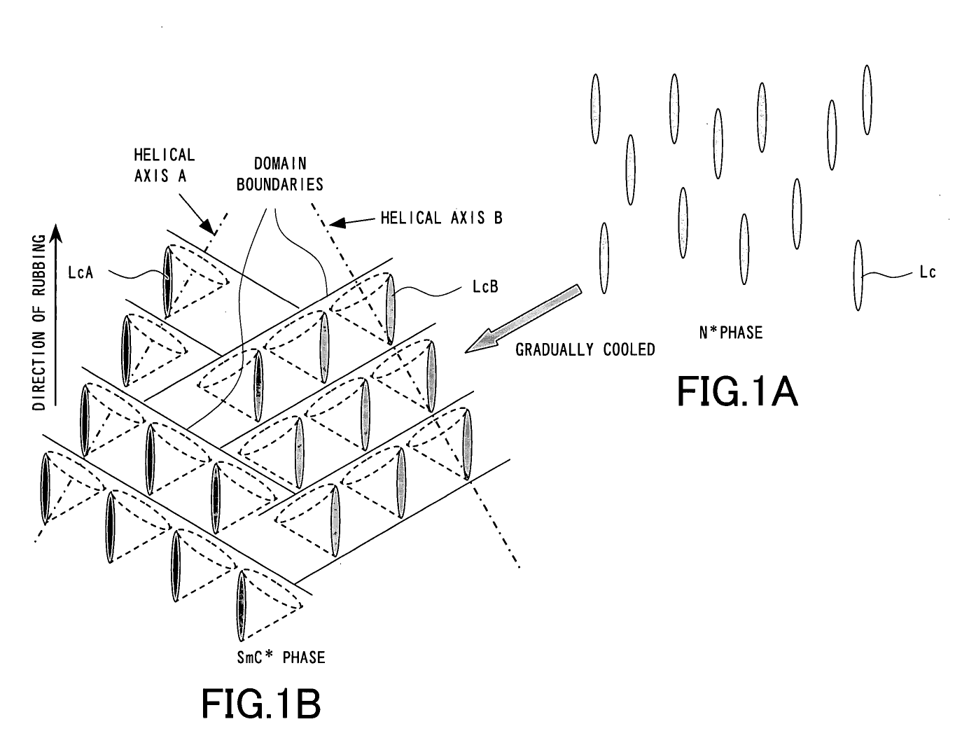

A liquid crystal display device according to an embodiment of the invention will now be described with reference to FIGS. 1A to 7B. First, means for solving the difficulty in controlling the alignment of monostable ferroelectric liquid crystals will be described with reference to FIGS. 1A to 3B. FIGS. 1A and 1B illustrate a state of alignment of a chiral smectic C-phase of when there is applied no voltage for aligning treatment. When the monostable ferroelectric liquid crystals in the isotropic phase or the (chiral) nematic phase (hereinafter expressed as N*-phase) are poured into between the opposing substrates and are maintained at a predetermined temperature, the liquid crystal molecules Lc are aligned along the direction of rubbing the alignment film as shown in FIG. 1A. Next, when a panel sealing the monostable ferroelectric liquid crystals is gradually cooled at a temperature gradient of, for example, −0.3° C./min, and is transited into the chiral smectic C-phase (hereinafter expressed as SmC*-phase), the alignment becomes as shown in FIG. 1B. Referring to FIG. 1B, the liquid crystal molecules LC are monostably aligned in the same direction along the direction in which the alignment film is rubbed. Here, however, two domains in which two helical axes A and B of different axial azimuths are mixing, are formed in a random fashion. Therefore, there are formed domains of liquid crystal molecules LcA having the helical axis A and domains of liquid crystal molecules LcB having the helical axis B, and the domain boundaries appear as a defect.

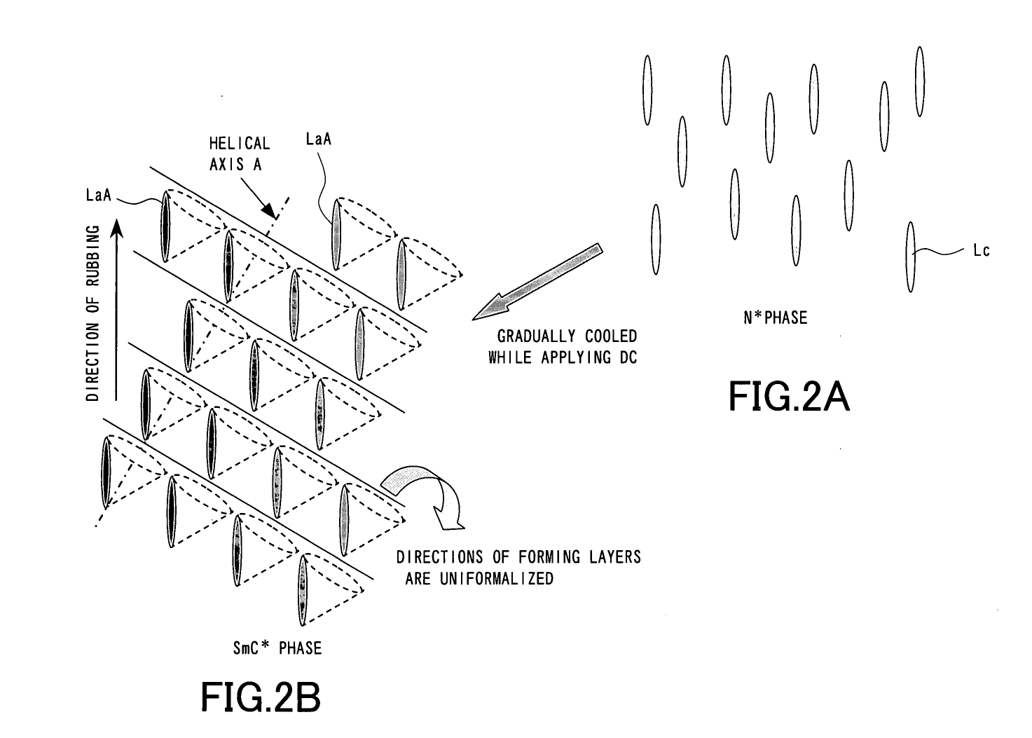

FIGS. 2A and 2B illustrate a state of alignment of the SmC*-phase of when a predetermined voltage (hereinafter referred to as aligning treatment voltage) is applied for aligning treatment. Referring to FIG. 2A, when the liquid crystals of the N*-phase are gradually cooled, the liquid crystals of the N*-phase having the liquid crystal molecules Lc that are arranged along the direction in which the alignment film is rubbed, while applying thereto, as an aligning treatment voltage, a DC voltage higher than a threshold voltage, then, there is formed a layer of the SmC*-phase of the helical axis A only comprising, for example, the liquid crystal molecules LcA only and having axis bearings arranged in one direction as shown in FIG. 2B. In this case, a uniform alignment is obtained and there occurs no domain boundary.

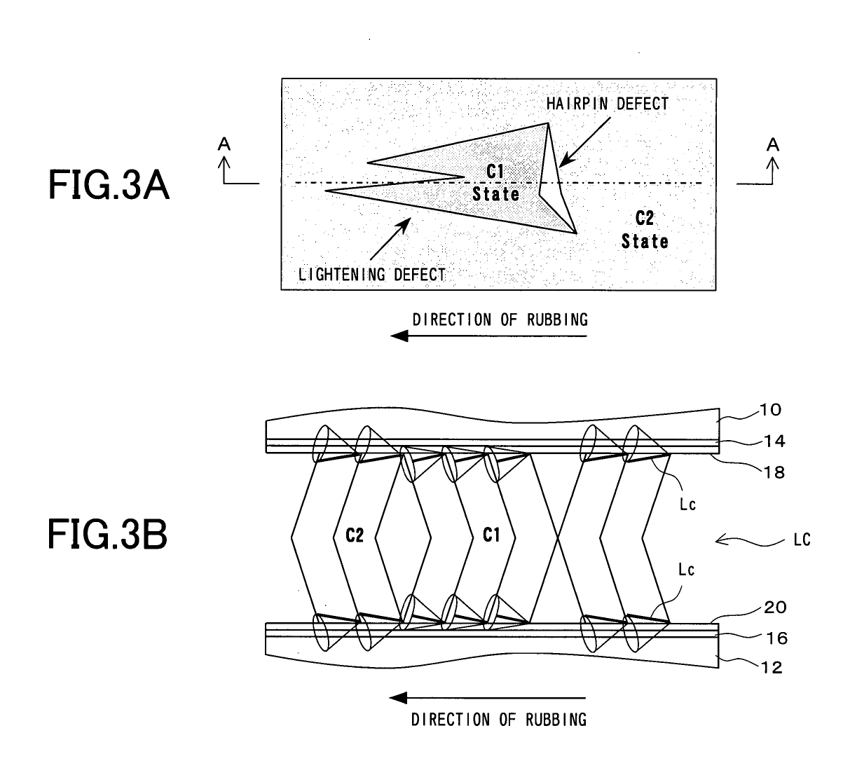

Next, described below with reference to FIGS. 3A and 3B are a pre-tilt expression direction and two states of alignment in the SmC*-phase. FIG. 3A schematically illustrates a state of observing the liquid crystal layer in a direction perpendicular to the substrate surface. FIG. 3B is a sectional view cut along the line A-A in FIG. 3A. Referring, first, to FIG. 3B, monostable ferroelectric liquid crystals LC are sealed between the upper substrate 10 and the lower substrate 12 which are facing each other maintaining a predetermined cell gap. An upper electrode 14 and an upper alignment control layer (alignment film) 18 are formed in this order on the upper substrate 10 on the side of the monostable ferroelectric liquid crystals LC. The upper alignment control layer 18 has been rubbed in a direction of from the right to the left in the drawing. A lower electrode 16 and a lower alignment control layer 20 are formed in this order on the lower substrate 12 on the side of the monostable ferroelectric liquid crystals LC. The lower alignment control layer 20, too, has been rubbed in a direction from the right to the left in the drawing.

When no voltage is applied across the upper electrode 14 and the lower electrode 16, the liquid crystal molecules LC near the upper and lower alignment control layers 18, 20 are aligned being tilted at a predetermined pre-tilt angle from the upper and lower alignment control layers 18, 20 toward the direction of rubbing. Since the upper and lower alignment control layers 18 and 20 have the same direction of rubbing, the long axes of liquid crystal molecules LC near the upper and lower alignment control layers 18 and 20 do not become in parallel with each other (hereinafter referred to as anti-parallel).

In the ferroelectric liquid crystals in the SmC-phase, in general, when the pre-tilt expression directions of the upper and lower alignment control layers 18 and 20 are anti-parallel as shown in FIG. 3B, the chevron-layer structure is bent in two states called C1 and C2 depending on the combinations of the directions of tilt of the layers and the pre-tilt expression directions. Right after the transition of phase due to gradual cooling from the high temperature side, there dominantly takes place a state C1 where there is formed a chevron-layer structure in which the inside (center side of the liquid crystal layer LC) of the upper and lower alignment control layers 18, 20 is so bent as to be retracted in a direction reverse to the direction of alignment. Then, as the tilt angle increases, there takes place the state C2 forming the chevron-layer structure in which the inside of the upper and lower alignment control layers 18, 20 is so bent as to protrude in the direction of alignment. At this moment, when the state C1 and the state C2 exist together, as shown in FIG. 3A, there occur a defect called zig-zag defect (also called lightening defect or hairpin defect depending upon the shape that is seen) on the boundary between the state Cl and the state C2, causing a drop in the contrast and shading of display. It is therefore important that the alignment is uniformalized to either the state C1 or the state C2. Further, the monostable ferroelectric liquid crystals require the application of a voltage for aligning treatment.

The present inventors have examined the above matters through vigorous trials, and have discovered the presence of certain definite conditions that had not so far been clarified to realize a contrast of a level comparable to that of the traditional TN liquid crystals. Namely, the inventors have discovered that a favorably aligned state can be obtained by transiting the state of alignment in the SmC*-phase from the initial state of C1 to the state of C2 in which the layer is bent in the reverse direction while applying a voltage for aligning treatment to the monostable ferroelectric liquid crystals LC.

As for a condition of applying the voltage for aligning treatment, if the voltage is increased to be greater than a voltage at an inflection point on a curve of voltage vs. transmission factor characteristics, then, the state C2 can be expressed on the whole display region. At the same time, however, it has been discovered that if the voltage is too high, stress is exerted on the liquid crystal molecules to an excess degree and the contrast drops. To maintain the contrast, the voltage for aligning treatment must be smaller than a saturation voltage.

As a condition required for the alignment control layers 18 and 20, further, it is important, for favorably expressing the state C2, that the material exhibits a pre-tilt angle which is not smaller than 0° C. but is not larger than 3° C. in a state where the ferroelectric liquid crystals are exhibiting the nematic phase. It is further desired to use an organic polymer film without having a side chain alkyl structure as the alignment control layers 18 and 20. The state C1 tends to remain as the alkyl side chains are imparted to the alignment control layers 18 and 20.

The smectic liquid crystals (ferroelectric liquid crystals) are closer to crystals than the nematic liquid crystals. In the treatment for alignment by rubbing with a cloth, therefore, the directions of hair tips and microscopic differences in the stiffness of hair tips turn out to be traces of stripes in the alignment. Unlike the nematic liquid crystals, therefore, the liquid crystal molecules are not profiled in an averaged manner in the direction of director. As a uniform aligning treatment with weak anchoring, therefore, it is desired to carry out an indirect aligning treatment. From the standpoint of alignment, in particular, the most smart alignment can be realized by a method that controls the alignment by expressing optical anisotropy in the alignment control layers 18 and 20 by the irradiation with an ultraviolet rays.

Concerning the ferroelectric liquid crystal display device according to the embodiment of the present invention, described below, first, is a conventional example, followed by some concrete examples.

### Conventional Example 1

Referring to FIGS. 3A and 3B, an upper alignment control layer 18 and a lower alignment control layer 20 were formed by applying an alignment film material LQ-T120-04 manufactured by Hitachi Kasei-du Pont Co. onto two pieces of glass substrates 10 and 12 with electrodes 14 and 16 formed by using ITO (indium tin oxide) which is a transparent electrode material, followed by firing. After the alignment control layers 18 and 20 were subjected to the parallel rubbing (rubbing directions of the two substrates after stuck together were in agreement), the two pieces of glass substrates 10 and 12 were stuck together in a manner that the alignment control layers 18 and 20 faced to each other maintaining a predetermined gap and, then, monostable ferroelectric liquid crystalline material LC manufactured by Clariant Co. in an isotropic phase was poured therein.

Then, while applying a DC voltage of 3.5 V across the two electrodes 14 and 16, the monostable ferroelectric liquid crystalline material was gradually cooled so as to assume the SmC*-phase. Application of voltage was discontinued at a moment when the SmC* transition temperature (about 60° C.) has dropped by another 5° C., and the gradual cooling was continued down to room temperature.

The thus fabricated liquid crystal cell was observed for its state of alignment to find that nearly the whole surface was in the state C1. Another liquid crystal cell to which no voltage was applied at the time of gradual cooling after the injection was similarly observed to find that the surface was in the state C1. A further liquid crystal cell to which a DC voltage of 7.0 V was applied was also observed to notice no great change in the state of alignment.

A pre-tilt angle of the monostable ferroelectric liquid crystals LC in the nematic phase was measured by a crystal rotation method to be 6 to 7°.

In the state of alignment, striped defects were seen over the whole surface, and light leaked from the defective portions in a dark state. Measurement by using a brightness meter, LCD-7000, manufactured by Otsuka Denshi Co. indicated a black transmission factor of 0.192% and a contrast of 53 (when aligned at DC 3.5 V).

### EXAMPLE 1

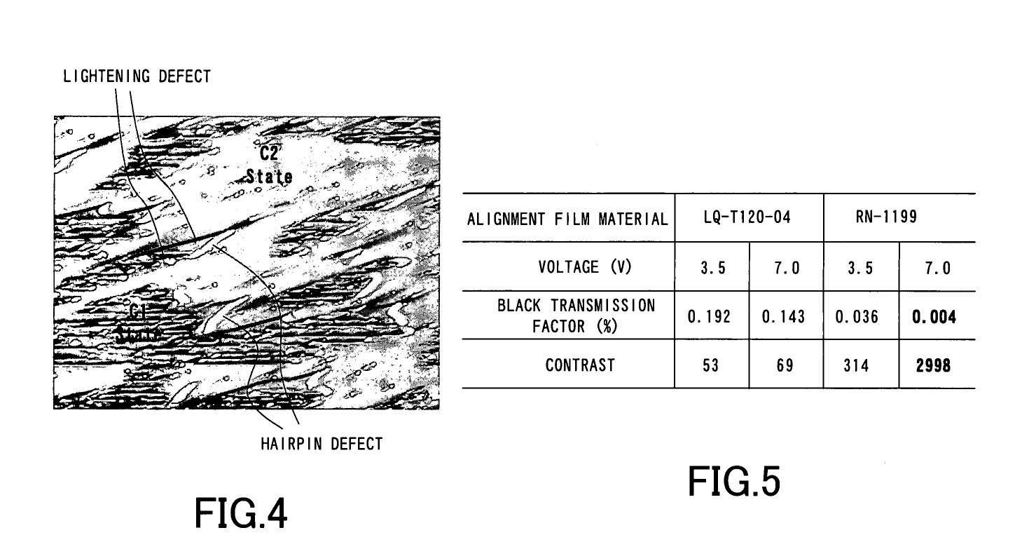

The same experiment as that of Conventional Example 1 was conducted by using the alignment film material LQ-T120-LT containing a decreased amount of alkyl side chains which express pre-tilt. Observation of the state of alignment indicated that about 60% assumed the state C2 when an aligning treatment voltage of 3.5 V was applied. When the aligning treatment voltage of 7.0 V was applied, not less than 70% assumed the state C2. The state C1 and the state C2 were observed through a microscope, and it was learned that the state C2 was very uniform and smooth as shown in FIG. 4. A great decrease in the leakage of light in a dark state (black display) was also confirmed.

Like in the Conventional Example 1, a pre-tilt angle of the monostable ferroelectric liquid crystals LC in the nematic phase was measured by the crystal rotation method to be 3 to 4°.

### EXAMPLE 2

The same experiment as that of Example 1 was conducted by using the alignment film material RN-1199 without alkyl side chain manufactured by Nissan Kagaku Co. Observation of the state of alignment indicated that when the aligning treatment voltage of 3.5 V was applied, zig-zag alignment defect scattered much though the state C2 took place dominantly. Next, when the state of alignment was observed while applying 7.0 V, the state C2 was realized over the whole surfaces. When the aligning treatment voltage was not applied, on the other hand, the state C1 was observed much. FIG. 5 shows the results of measurement by using a brightness meter LCD-7000 manufactured by Otsuka Denshi Co. FIG. 5 compares the black transmission factors (%) and contrasts of the liquid crystal cells obtained by using the alignment film materials LQ-T120-04 and RN-1199 and gradually cooling them while applying aligning treatment voltages of 3.5 V and 7.0 V, respectively. From FIG. 5, both the black transmission factor and contrast are greatly improved when RN-1199 is used as compared to when the conventional LQ-T120-04 is used.

Like in the Conventional Example 1, a pre-tilt angle of the monostable ferroelectric liquid crystals LC in the nematic phase was measured by the crystal rotation method to be 1 to 2°.

### EXAMPLE 3

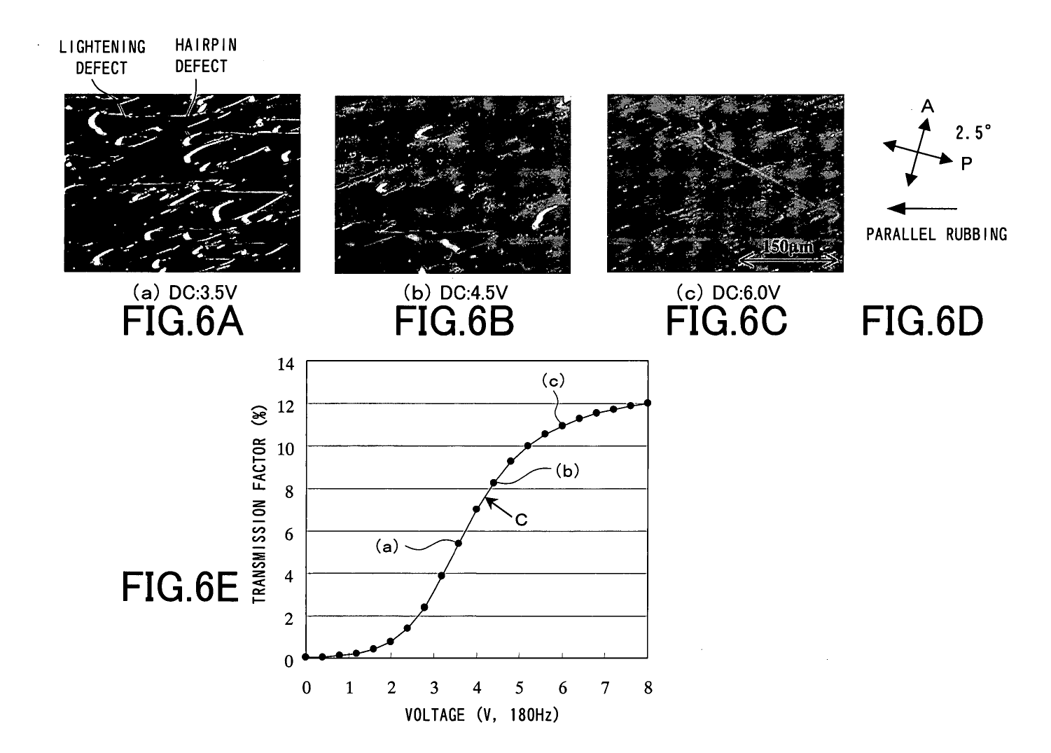

A liquid crystal cell was fabricated by forming upper and lower alignment control layers 18 and 20 by using the alignment film material RN-1199 like in Example 2, and a change in the state of alignment depending upon the aligning treatment voltages was observed. The results were as shown in FIGS. 6A to 6E. FIGS. 6A to 6C illustrate the surface states of the liquid crystal layer of when there are applied orientation voltages of DC 3.5 V, DC 4.5 V and DC 6.0 V. The transverse arrow in FIG. 6C has a length of 150 μm. FIG. 6D is a diagram illustrating a relationship of arrangement between the direction of parallel rubbing of the upper and lower alignment control layers 18, 20 of liquid crystal cells shown in FIGS. 6A to 6C and the polarizing plates (not shown) stuck to both surfaces of the glass substrate of the liquid crystal cell. As shown in FIG. 6D, the rubbing is effected from the right toward the left in the drawing. Further, the polarizer plates which are not shown are arranged in a cross-nicol relationship, and the axes of polarization (axes of absorption) P and A of the two pieces of polarizer plates meeting at right angles are arranged being rotated by 2.5° in the clockwise direction with respect to the up-and-down and right-and-left axes in the drawing.

As shown in FIGS. 6A to 6C, it is learned that the state C2 becomes dominant as the aligning treatment voltage increases, and the whole surface finally assumes the state C2.

FIG. 6E is a diagram illustrating a curve of voltage vs. transmission factor characteristics of the liquid crystal cell, wherein the abscissa represents the voltage (V) and the ordinate represents the transmission factor (%). 180 Hz on the abscissa is a frequency for inverting the polarity of voltage applied to the liquid crystals when the image is to be really displayed. Further, a point Con the curve of voltage vs. transmission factor characteristics is an inflection point, and (a), (b) and (c) are corresponding to FIGS. 6A, 6B and 6C, respectively.

As shown in FIG. 6E, a voltage for transiting the whole surface into the state C2 is at the position (b) on the curve of voltage vs. transmission factor characteristics, which is slightly higher than the voltage at the inflection point C. When the aligning treatment voltage is further increased and a voltage of not lower than the saturation voltage at which the transmission factor does not change, is applied, it is learned that the order of alignment of liquid crystals is disturbed and light leaks in the black state though the state C2 is maintained.

### EXAMPLE 4

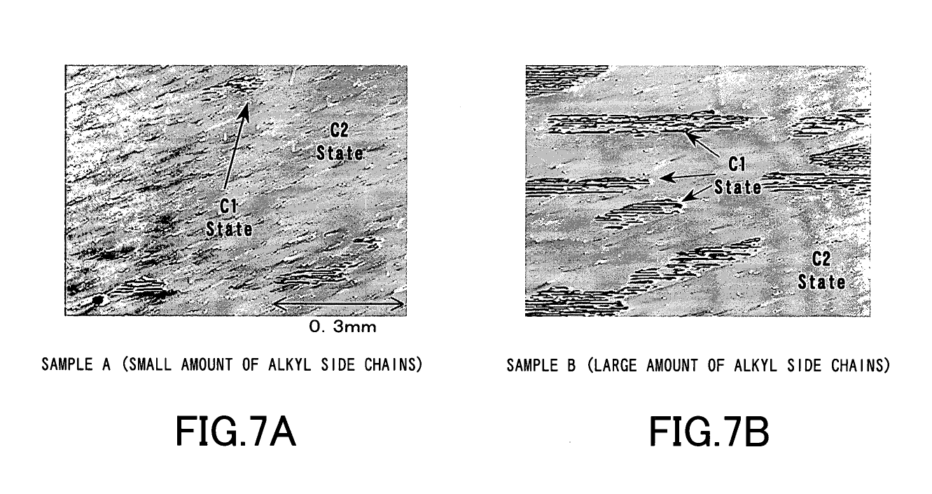

Alkyl side chains were imparted to the material RN-1199 without alkyl side chain used in Example 2 to see changes in the pre-tilt angle and in the state of alignment. FIG. 7A illustrates a surface state of the liquid crystal layer of when the amount of the alkyl side chains is relatively small (sample A). The transverse arrow in FIG. 7A has a length of 0.3 mm. FIG. 7B illustrate the surface state of the liquid crystal layer of when the amount of the alkyl side chains is relatively large (sample B) on the same scale as in FIG. 7A. FIGS. 7A and 7B show the results of when 7.0 V is applied as an aligning treatment voltage. As the pre-tilt angle increases with an increase in the aligning treatment voltage, the state C1 remains at an increasing ratio. In the sample A of FIG. 7A, nearly the whole surface assumes the alignment C2 with the application of 10 V, but tiny regions C1 are still locally observed. In the sample B, the state C1 never extinguishes.

### EXAMPLE 5

A liquid crystal cell was fabricated by using a polyvinyl cinnamate (PVCi) as an alignment film material. Here, as the aligning treatment, the surface of the alignment control layers were irradiated with polarized UV (ultraviolet ray). The state of alignment was observed. When the rubbing is effected, striped shading is always observed to a slight degree being affected by the hair tips of the rubbing cloth (due to slight differences in the direction and intensity of hair tips during the rubbing). The liquid crystal cell of the embodiment, however, exhibited very highly ordered and homogeneous alignment.

As described above, the embodiment of the invention makes it possible to easily provide a liquid crystal display device that features excellent contrast that could not be realized thus far while utilizing half tone display characteristics, high-speed response and wide temperature range characteristics of the monostable ferroelectric liquid crystals. Further, the invention makes it possible to provide a liquid crystal display device that copes with dynamic images by utilizing the field sequential drive.

According to this invention as described above, there is realized a liquid crystal display device that features excellent contrast while utilizing half tone display characteristics, high-speed response and wide temperature range characteristics of the monostable ferroelectric liquid crystals.

What is claimed is:

1. A liquid crystal display device comprising:
an upper substrate on which are arranged an upper electrode for applying a voltage, and an upper alignment control layer formed on the upper electrode and performed an aligning treatment;
a lower substrate on which are arranged a lower electrode for applying a voltage in cooperation with the upper electrode, and a lower alignment control layer formed on the lower electrode and performed an aligning treatment in the same direction as the upper alignment control layer; and
monostable ferroelectric liquid crystals sealed between the upper alignment control layer and the lower alignment control layer, and forming a chevron-layer structure which is so bent that the inside from both sides of the upper and lower alignment control layers is protruded in the direction of the aligning treatment.

2. A liquid crystal display device according to claim 1, wherein the alignment control layers are organic polymer films without side chain alkyl structure.

3. A method of producing a liquid crystal display device comprising:
sticking an upper substrate on which is arranged an upper alignment control layer that is formed on an upper electrode and is performed an aligning treatment, together with a lower substrate on which is arranged a lower alignment control layer that is formed on a lower electrode and is performed an aligning treatment in the same direction as the upper alignment control layer;
sealing monostable ferroelectric liquid crystals between the upper alignment control layer and the lower alignment control layer; and
transiting the phase of the monostable ferroelectric liquid crystals from the isotropic phase or the (chiral) nematic phase into the chiral smectic phase while applying a DC voltage across the upper electrode and the lower electrode to uniformalize the helical axes of the liquid crystal molecules and, at the same time, transiting the direction in which the chevron-layer structure is bent into a direction opposite to the direction in which the chevron-layer structure is bent when the DC voltage is not applied.

4. A method of producing a liquid crystal display device according to claim 3, wherein the DC voltage is larger than a voltage at an inflection point on a curve of voltage vs. transmission factor characteristics but is smaller than a saturation voltage in the normally black display.

5. A method of producing a liquid crystal display device according to claim 3, wherein the pre-tilt angle is not smaller than 0° but is not larger than 3° in a state where the monostable ferroelectric liquid crystals are exhibiting a nematic phase.

6. A method of producing a liquid crystal display device according to claim 4, wherein the pre-tilt angle is not smaller than 0° but is not larger than 3° in a state where the monostable ferroelectric liquid crystals are exhibiting a nematic phase.

7. A method of producing a liquid crystal display device according to claim 3, wherein an organic polymer film without side chain alkyl structure is used as the alignment control layers.

8. A method of producing a liquid crystal display device according to claim 4, wherein an organic polymer film without side chain alkyl structure is used as the alignment control layers.

9. A method of producing a liquid crystal display device according to claim 5, wherein an organic polymer film without side chain alkyl structure is used as the alignment control layers.

10. A method of producing a liquid crystal display device according to claim 6, wherein an organic polymer film without side chain alkyl structure is used as the alignment control layers.
